(19) United States
(12) Patent Application Publication
(10) Pub. No.: US 2011/0055881 A1
(43) Pub. Date: Mar. 3, 2011

(54) MEDIA FILE ON-DEMAND METHOD, SYSTEM AND APPARTUS

(75) Inventors: De Yu, Shenzhen (CN); Taowei Wang, Shenzhen (CN)

(73) Assignee: TENCENT TECHNOLOGY (SHENZHEN) COMPANY LIMITED, Shenzhen (CN)

(21) Appl. No.: 12/863,151

(22) PCT Filed: May 12, 2009
(86) PCT No.: PCT/CN2009/071738

§ 371 Date: Jul. 15, 2010

(30) Foreign Application Priority Data
May 29, 2008 (CN) 200810111384.9

(51) Int. Cl. H04N 7/173

(52) U.S. Cl. 725/88

(57) ABSTRACT

The present invention discloses a media file on-demand method, comprising: the server, upon receiving the media on-demand request from the client, provides the index information in the self-defining media file to the client; the server, upon receiving the playing progress request from said client, according to the requested time in the playing progress request, searches for the starting offset position of the media data corresponding to the requested time in the index information; the server, according to the starting offset position of the media data, reads out the media data corresponding to the requested time in the self-defining media file, and provides the media data to the client. The present invention further discloses a media file on-demand system and apparatus, wherein the index information derived by analyzing the original media file divides the original media file into individual segments according to time, thus the user, upon watching the program and dragging on the progress bar, is enabled to request the data according to the time so as to quickly acquire the media data at the time corresponding to the drag-and-drop position, so the experience of use by the user is enhanced.

### BACKGROUND OF THE INVENTION

1. Field of the Invention Technical Field

The present invention relates to the multimedia on-demand technique, in particular, to a media file on-demand method, a system and an apparatus.

2. Description of the Related Art

With the development of social economy and scientific and technological progress, users are increasingly demanding for the data and image services, in particular in the multimedia service respect, thus to exploit a new type of bandwidth service becomes an important goal of the information industry, while VOD (Video on Demand) service is one of the typical applications that is the most representative among broadband services. The VOD (Video on Demand) enables the users to freely request the media program in the streaming media server via computer or television according to their own interests, thus the users may fully take the initiative so as to essentially overcome the deficiency that the users watch the program passively.

Conventional VOD provides on-demand service by adopting client/server (C/S) connecting mode. Due to the limitation of input/output (I/O) bottleneck, one streaming media server can only support limited concurrent streams; while in order to address the challenge that the number of users watching the program simultaneously is on the order of one hundred thousand or one million, not only a multitude of streaming media servers but also an extremely broad network bandwidth are necessary. Thus, the C/S mode has become a bottleneck inhibiting the development of VOD.

Current VOD systems mostly utilize the P2P (Peer to Peer) technique, the P2P technique is such that the share of computer resources and information is achieved through a direct exchange between the systems. With the P2P technique, a plurality of user terminals are combined into one network, so as to share the bandwidth therein, and process the information therein in a cooperative manner. Different from the conventional C/S mode, with the working style of P2P, each user terminal is both a client and a server. To take the shared downloading file as an example, among the plurality of user terminals downloading the one and the same file, each user terminal needs downloading only one of many segments composing the file, which segments are then exchanged mutually, so that eventually each user terminal can get a complete file. With the P2P technique, the user terminal while enjoying the server resources may also provide services for other user terminals with its own spare resources; due to the fact that the resource may be transmitted peer to peer, not necessarily by way of the streaming media server, the bandwidth expense of the streaming media server may be saved, thus meeting the requirement of online program on-demand simultaneously by a multitude of users with the limited resource of bandwidth.

With the prior VOD technique, the media file can not be divided into segments according to the time, thus, when a user is watching the media program and dragging on the progress bar, the client may, only according to the length proportion of the progress bar to the total schedule, requests the media data located at the same proportion with respect to the total size of the media file from the server. For example, the user drags the progress bar to half of the total schedule, then the client requests the media data located at half of the total size of the media file from the server. However, due to the fact that there are differences between the size of each of the data packets in the media file, generally, the time duration of the media file does not equally proportionally correspond to the size of the media file. For example, as to a media file with a size of 100 megabyte, if it takes a total time duration of 1800 seconds to play this media file, then the media data located at the 50th megabyte may not invariably be played at the 900th second; likewise, what is played at the 450th second may not invariably be the media data located at the 25th megabyte.

Whereby it is seen that, with the prior VOD technique, the request for the media data by the user dragging on the progress bar on the client is not carried out according to real time, and the server has to make an online analysis on the media file according to the progress request of the client, so as to locate the media data requested, which process requires a relatively long delay time. Since the prior art is incapable of quickly locating the media data in the media file according to the progress request of the client, the delay time lasting from dragging on the progress bar to playing the media program is caused to be relatively long, thus resulting in a poor experience of use for the user.

### SUMMARY OF THE INVENTION

The primary object of the present invention is to provide a media file on-demand method, a system and an apparatus, so as to address the problem that in the existing media playing process, the delay time upon dragging on the progress bar is relatively long.

To achieve the above-described object, the technical solution of the present invention is as follows:

The present invention provides a media file on-demand method, comprising:

the server, upon receiving the media on-demand request from the client, provides the index information in the self-defining media file generated in advance according to the original media file to said client;

the server, upon receiving the playing progress request from said client, according to the requested time carried in said playing progress request, searches for the starting offset position of the media data corresponding to said requested time in said index information;

the server, according to said starting offset position of the media data, reads out the media data corresponding to said requested time in said self-defining media file, and provides said media data to said client.

The present invention further provides a media file on-demand method, comprising:

the client sends a media on-demand request to the server, and receives the index information from said server;

in the media playing process, the client, according to said index information, acquires the requested time corresponding to the drag-and-drop position of the progress bar, and sends said requested time to said server by carrying it in the playing progress request;

the client receives the media data corresponding to said requested time from said server, and performs media playing.

The present invention further provides a media file on-demand system, comprising:

a client, said client sends a media on-demand request to the server; according to the index information from the server, acquires the requested time corresponding to the drag-and-drop position of the progress bar, and sends said requested time to said server by carrying it in the playing progress request; receives the media data corresponding to said requested time from said server, and performs media playing;

a server, said server provides the index information in the self-defining media file generated in advance according to the original media file to said client, according to the requested time in the playing progress request from said client, searches said index information for the starting offset position of the media data corresponding to said requested time; and according to said starting offset position of the media data, reads out the media data corresponding to said requested time in said self-defining media file, and provides said media data to said client.

The present invention further provides a server, comprising:

an index information providing module, said index information providing module, upon receiving the media on-demand request from the client, provides the index information in the self-defining media file to said client, and is used for said server itself searching the index information;

a starting offset position searching module, said starting offset position searching module, upon receiving the playing progress request from said client, according to the requested time in said playing progress request, searches said index information to get the starting offset position of the media data corresponding to said requested time;

a media data reading module, said media data reading module, according to said starting offset position of the media data, reads out the media data corresponding to said requested time in said self-defining media file, and provides said media data to said client.

The present invention further provides a client, comprising:
a sending module, said sending module sends the media on-demand request and the playing progress request to the server, said playing progress request carrying the requested time therein;

a requested time acquiring module, said requested time acquiring module, in the media playing process, acquires the requested time corresponding to the drag-and-drop position of the progress bar;

a receiving module, said receiving module receives the index information and the media data from said server.

According to the media file on-demand method, system and apparatus provided by the present invention, the index information is derived by analyzing the original media file, which index information, without modifying the original media file, divides the original media file into individual segments according to the time and records the related information as to whether every second of media data contains a key frame; the index information is written to the header or the end of the original media file so as to create a new self-defining media file; with the present invention, upon watching the program and dragging on the progress bar, the user is enabled to request the data according to the time so as to quickly acquire the media data at the time corresponding to the drag-and-drop position from the server, thus the delay time upon dragging on the progress bar is shortened and the experience of use by the user is enhanced; and due to the fact that in the present invention the original media file is logically segmented in the unit of time, thus, as to an on-demand system of the P2P mode, any user terminal, after requesting one segment in the original media file, may report the resource information of its own to the streaming media server so as to become a valid seed, which may share the local media data with other user terminals, thus the share of resources is achieved to the maximum degree, and the network bandwidth is reduced more effectively.

### BRIEF DESCRIPTIONS OF THE DRAWINGS

FIG. 1 is the flow chart of the media file on-demand method implemented by the server in the present invention;

FIG. 2 is the flow chart of the media file on-demand method implemented by the client in the present invention;

FIG. 3 is a composing structure illustrating view of a media file on-demand system of the present invention.

### DETAILED DESCRIPTION OF THE PREFERRED EMBODIMENTS

To make the object, the technical solution and the advantage of the present invention more clearly and explicitly expressed, the present invention is hereinafter described in further detail in connection with the accompanying drawings and the particular embodiments thereof.

In the present invention, the original media file is preprocessed in the streaming media server, so as to derive the index information corresponding to the original media file by analyzing, comprising: the total time duration of the original media file, the total number of the data packets of the original media file, the size of each data packet, the size of the header of the original media file, the average bit rate, the total number of the memory management units, the starting offset position of media data of each second in the original media file, whether media data of each second containing a key frame, the number of the memory management units contained in each second, the number of the data packets contained in media data of each second and so on. The index information derived by analyzing is saved in the data structure, and is written to the end or the header of the original media file in the binary manner so as to create a new self-defining media file. It is needed to note that, to write the index information to the header of the original media file causes the change of the position of the original media file, thus necessitating modifying the position of the original media file; while to write the index information to the end of the original media file does not need to modify the position of the original media file, the operation thereof is relatively simple, thus, in the practical application it is preferable to write the index information to the end of the original media file.

The data structure saving the index information is as follows by way of example:

#ifndef_FRAME_INDEX_H
#define_FRAME_INDEX_H
/*the max seconds in one wmv file*/

| | |
|---|---|
| #define MAX_DURATION | 3600*4 |

/*the size of memory manage unit */

| | |
|---|---|
| #define | MEM_MGR_UNIT |

1*1024*1024
/*the max number of memory manage unit in one wmv file*/

| | |
|---|---|
| #define MEDIA_FILE_MAX_MEM_MGR_UNITS | 1000 |

/* designed for mem manage unit */
#endif

The above-described data structure comprises the macro definitions of variable therein. The maximum time duration of the media file MAX_DURATION is defined to be 3600*4 seconds, that is, 4 hours; the size of the memory management unit MEM_MGR_UNIT is defined to be 1*1024*1024 bytes, that is, 1M; the maximum number of the memory management units MEDIA_FILE_MAX_MEM_MGR_UNITS is defined to be 1000. The so-called memory management unit refers to that the server divides the memory storage space of its own into a plurality of memory management units, and caches in the unit of second the media data read out from the disc into each memory management unit in blocks, so that upon the next time the media is on-demand and said media data is required to be read out, the server may directly read it out from the memory without reading the disc once more, thus the efficiency can be improved. Furthermore, in consideration of the memory storage space being limited, in case the memory space is full, the media data with a lower frequency on-demand is deleted from the memory by the elimination algorithm, so some spare space is left for storing new media data. Therefore, in the practical application, usually the media data with a higher frequency on-demand is stored in the memory management unit, while the media data with a lower frequency on-demand is stored in the disc.

The above-described data structure further comprises the beginning second of each memory management unit and the ending second thereof, as well as the index information derived by analyzing the original media file, comprising: the total time duration of the original media file, the total number of the data packets of the original media file, the size of each data packet, the size of the header of the original media file, the average bit rate, the total number of the memory management units, the starting offset position of media data of each second in the original media file, whether media data of each second containing a key frame, the number of the memory management units contained in media data of each second, the number of the data packets contained in media data of each second and so on.

It should be noted that, in the present invention, the preprocessing of the original media file supports two operation manners, that is, online and offline preprocessing. The so-called offline preprocessing refers to that, the user analyzes the original media file with the preprocessing tools in an offline situation so as to derive the index information, and generates the self-defining media file composed by the original media file and the index information, then uploads the after-preprocessed self-defining media file to the streaming media server. The so-called online preprocessing refers to that, the streaming media server analyzes the uploaded original media file and generates the self-defining media file composed by the original media file and the index information. Whereby, it is seen that, the online preprocessing needs to experience a certain online time delay and places a higher requirement on the performance of the streaming media server. Thus, in the practical application, the offline preprocessing manner is preferably adopted.

The media file on-demand method achieved in the present invention based on the above-described preprocessing operation is suitable for the on-demand systems of both the C/S mode and the P2P mode. The common point lies in that, in both modes of the on-demand system, the original media file is preprocessed in the streaming media server, analyzed to derive the index information. The difference lies in that, in the C/S mode of the on-demand system, each user terminal acquires the media file invariably from the streaming media server, that is, the provider of the media file is exclusively the streaming media server; while in the P2P mode of the on-demand system, the media file is initially transmitted from the streaming media server to the user terminal in the P2P network, however, since the P2P supports the transmission of resources between the user terminals, thus, the provider of the media file may be either the streaming media server, or the user terminal possessing the media file.

In the present invention, for convenience of description, the apparatus acting as the media file provider are generally called the server, while the apparatus acting as the media file receiver are generally called the client. Therefore, in the C/S mode of the on-demand system, the server refers to the streaming media server, the client refers to the user terminal; while in the P2P mode of the on-demand system, the server may be the streaming media server, and may also be the user terminal possessing the media file, and the client refers to the user terminal requesting for receiving the media file.

Next, the media file on-demand method of the present invention is described in detail in connection with the implementation thereof in the server. As shown in FIG. 1, FIG. 1 is the flow chart of the media file on-demand method implemented by the server in the present invention, which method mainly comprises the following steps:

Step 101, the server, upon receiving the media on-demand request from the client, provides the index information in the self-defining media file to the client.

When the client needs to request the self-defining media file on the server, it sends a media on-demand request to the server; while the server, after receiving the media on-demand request from the client, first sends the index information in the self-defining media file to the client for the receipt thereof by the client.

Step 102, the server, upon receiving the playing progress request from said client, according to the requested time in the playing progress request, searches for the starting offset position of the media data corresponding to the requested time in the index information.

During the process in which the server plays the self-defining media file to the client, it searches the index information according to the requested time in the playing progress request from the client; since in the index information, the original media file is divided into segments according to the time, in the practical application usually in second, thus the server may locate the starting offset position of the media data corresponding to the requested time, according to the starting offset position of the media data of media data of each second in the original media file. For example: Assume that the time duration of a media file is 60 second, and is divided into 60 segments in second, with media data of each second respectively corresponding to a portion of the media data, that is, the starting time of media data of each second corresponding to a starting offset position in the original media file, then when the client requests the media data of the 45th second, the server may quickly locate the starting offset position in the media file corresponding to the starting time of the 45th second.

Step 103, the server, according to the starting offset position of the media data, reads out the media data corresponding to the requested time in the self-defining media file, and provides the media data to the client.

The server divides the memory storage space of its own into a plurality of memory management units, and caches in the unit of second the media data read out from the disc into each memory management unit in blocks, so that upon the next time the media is on-demand and said media data is required to be read out, the server may directly read it out from the memory without reading the disc once more, thus the efficiency can be improved. Furthermore, in consideration of the memory storage space being limited, in case the memory space is full, the media data with a lower frequency on-demand is deleted from the memory by the elimination algorithm, so some spare space is left for storing new media data. Therefore, in the practical application, usually the media data with a higher frequency on-demand is stored in the memory management unit, while the media data with a lower frequency on-demand is stored in the disc.

Next, the operation of the elimination algorithm is explained by way of example. Assume that the memory with a storage space of size 1G stores the media data A, B, C and D, Since these media data fully occupies the storage space of the memory, the frequency on-demand of the individual media data is compared with each other, and it is found that the frequency on-demand of the media data C is the lowest; thus the server deletes the media data C from within the memory, so some spare space is left in the memory for storing new media data. When the space of the memory is fully occupied again, the same operation described above is performed, so that the media file with the lowest frequency on-demand in the current memory is deleted.

To continue with the example in Step 102, after locating the starting offset position in the media file corresponding to the starting time of the 45th second, the server reads out the media data corresponding to the 45th second starting from this starting offset position, and provides the media data to the client; then, the server continues to read out the media data of the 46th second to the 60th second according to the sequence for storing the media data.

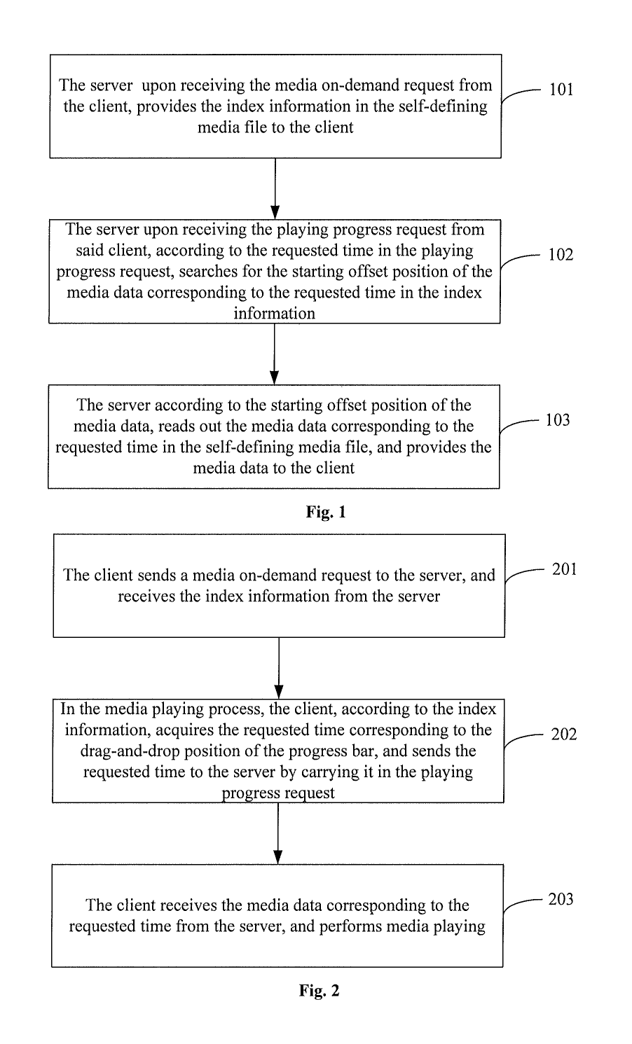

Next, the media file on-demand method of the present invention is further described in detail in connection with the implementation thereof in the client. As shown in FIG. 2, FIG. 2 is the flow chart of the media file on-demand method implemented by the client in the present invention, which method mainly comprises the following steps:

Step 201, the client sends a media on-demand request to the server, and receives the index information from the server.

Step 202, in the media playing process, the client, according to the index information, acquires the requested time corresponding to the drag-and-drop position of the progress bar, and sends the requested time to the server by carrying it in the playing progress request.

The client, according to the length proportion of the progress bar after the drag-and-drop operation to the total schedule and the total time duration of the original media file contained in the index information, calculates the first time corresponding to the drag position. Then, the server searches the index information. Due to the fact that the index information stores therein the information as to whether the media data of media data of each second contains a key frame, it may be judged whether the media data corresponding to the first time contains a key frame. If the key frame exists, then the first time is determined to be the requested time corresponding to the drag-and-drop position; otherwise, the second time containing a key frame, which is the closest to the first time is determined to be the requested time corresponding to the drag-and-drop position.

Not all the data packets in the media file each contain a key frame. However, it is through searching for the key frame that the media playing tool of the client plays the media data. In case the media data sent by the server to the client does not contain a key frame therein, then the player of the client can not find the key frame, which may result in the fail of the playing of the media file. Thus, in the present invention, by the operating solution described above, it may be ensured that the media data corresponding to the requested time sent by the client to the server contains a key frame, thus it is guaranteed that the media playing tool could play the media data normally. The explanation is given below by way of example:

The first time corresponding to the drag-and-drop position calculated by the client is the 30th second. According to the information as to whether the media data of each second contains a key frame, it is judged by the client that the media data of the 30th second does not contain a key frame therein, and through searching it is found that the media data of the adjacent 29th second does not contain a key frame either, while that of the adjacent 31st second contains a key frame, thus the 31st second is selected to be the requested time corresponding to the drag-and-drop position, and the requested time is sent to the server by being carried in the playing progress request. The server, upon receiving the playing progress request from the client, provides the media data of the 31st second instead of that of the 30th second to the client.

Step 203, the client receives the media data corresponding to the requested time from the server, and performs media playing.

To continue with the example in Step 202, starting from the 31st second, the server sequentially provides the media data after the 31st second to the client according to the storing order; while the client, starting from the 31st second, plays the media data in sequence, until the completion thereof.

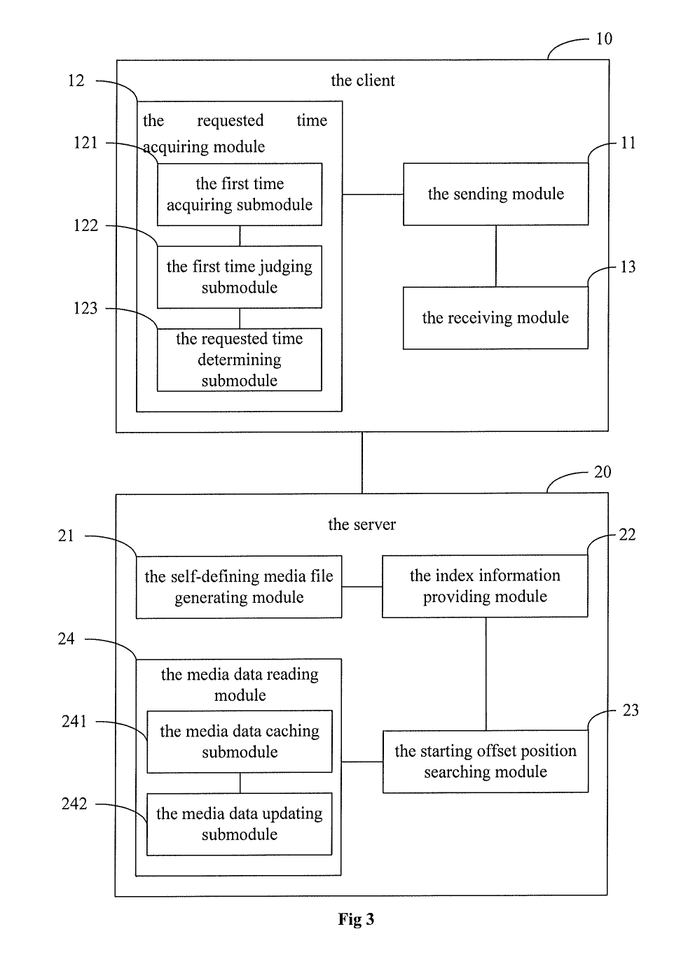

To achieve the above-described media on-demand method of the present invention, the present invention also provides a media on-demand system, as shown in FIG. 3, which comprises a client 10 and a server 20 that are interconnected. The client 10 sends a media on-demand request to the server 20, receives the index information from the server 20; in the process of media playing, according to the index information, acquires the requested time corresponding to the drag-and-drop position of the progress bar, and sends the requested time to the server 20 by carrying it in the playing progress request; further, receives the media data corresponding to the requested time from the server 20, and performs media playing. The server 20, upon receiving the media on-demand request from the client 10, provides the index information in the self-defining media file generated in advance according to the original media file to the client 10; further, upon receiving the playing progress request from the client 10, according to the requested time in the playing progress request, searches the index information for the starting offset position of the media data corresponding to the requested time; and according to the starting offset position of the media data, reads out the media data corresponding to the requested time in the self-defining media file, and provides said media data to said client 10.

Herein, the client 10 comprises: a sending module 11, a requested time acquiring module 12 and a receiving module 13. The sending module 11 sends the media on-demand request and the playing progress request to the server 20, the playing progress request carrying the requested time therein. The requested time acquiring module 12 is connected with the sending module 11, and in the media playing process, acquires the requested time corresponding to the drag-and-drop position of the progress bar. The receiving module 13, is connected with the sending module 11, and receives the index information or the media data from the server 20 according to the sent media on-demand request and playing progress request.

The requested time acquiring module 12 further comprises: a first time acquiring submodule 121, a first time judging submodule 122 and a requested time determining submodule 123. The first time acquiring submodule 121, according to the length proportion of the progress bar to the total schedule and the total time duration of the original media file contained in the index information, acquires the first time corresponding to the drag-and-drop position. The first time judging submodule 122 is connected with the first time acquiring submodule 121, searches the index information, and judges whether the media data corresponding to the first time contains a key frame. The requested time determining submodule 123 is connected with the first time judging submodule 122, and according to the result of the judgement, if the media data corresponding to the first time contains a key frame, then determines the first time to be the requested time corresponding to the drag-and-drop position, otherwise, selects the second time containing a key frame, which is the closest to the first time to be the requested time corresponding to the drag-and-drop position.

The server 20 comprises: a self-defining media file generating module 21, an index information providing module 22, a starting offset position searching module 23 and a media data reading module 24. The self-defining media file generating module 21 analyzes the original media file to derive the corresponding index information, and combines the original media file and the index information, so as to generate the self-defining media file. The index information providing module 22 is connected with the self-defining media file generating module 21, upon receiving the media on-demand request from the client 10, provides the index information in the self-defining media file generated in advance according to the original media file to the client 10, and is used for the server 20 itself searching the index information. The starting offset position searching module 23, is connected with the index information providing module 22, upon receiving the playing progress request from the client 10, according to the requested time in the playing progress request, searches the index information for the starting offset position of the media data corresponding to the requested time. The media data reading module 24 is connected with the starting offset position searching module 23, according to the starting offset position of the media data, reads out the media data corresponding to the requested time in the self-defining media file, and provides the media data to the client 10.

Herein, the media data reading module 24 further comprises a media data caching submodule 241 and a media data updating submodule 242 that are interconnected. The media data caching submodule 241 caches the media data read out by the server 20 from the disc of its own in the memory. The media data updating submodule 242, in case the memory space of the server 20 is full, deletes the media data that is not on demand for a long period from the memory through the elimination algorithm.

To sum up, due to the fact that in the present invention the original media file is analyzed in advance to derive the index information, in the process of playing the media file, the server is not needed to re-analyze the original media file, thus the response time of the server is shortened, that is, in the respect of the experience of use, the delay time is shortened upon dragging on the progress bar. In addition, in the present invention the original media file is logically segmented in the unit of time, thus the user is enabled to request the data more intuitively according to time so as to achieve a relatively fine experience of use.

The above are only relatively preferred embodiments of the present invention, instead of limiting the scope of protection of the present invention thereto.

1. A media file on-demand method, wherein said method comprises:
the server, upon receiving the media on-demand request from the client, provides the index information in the self-defining media file generated in advance according to the original media file to said client;
the server, upon receiving the playing progress request from said client, according to the requested time carried in said playing progress request, searches for the starting offset position of the media data corresponding to said requested time in said index information;
the server, according to said starting offset position of the media data, reads out the media data corresponding to said requested time in said self-defining media file, and provides said media data to said client.

2. The media file on-demand method as claimed in claim 1, wherein said method for generating the self-defining media file according to the original media file comprises:
the server analyzes said original media file to derive the index information corresponding to said original media file;
the server combines said original media file and said index information to generate said self-defining media file.

3. The media file on-demand method as claimed in claim 1, wherein said reading the media data corresponding to the requested time in the self-defining media file, and providing the media data to the client further comprises:
the server, while providing the media data read out from the disc of its own to the client, caches said media data into the memory, and said server, upon re-receiving the media on-demand request corresponding to said media data, reads out said media data from within said memory directly, and provides it to said client;
upon said caching the media data into the memory, in case said memory space is full, the media data with a lower frequency on-demand is deleted from said memory by the elimination algorithm, and said media data is cached into the memory.

4. The media file on-demand method as claimed in claim 1, wherein said index information comprises: the total time duration of the original media file, the total number of the data packets of the original media file, the size of each data packet, the size of the header of the original media file, the average bit rate, the total number of the memory management units, the starting offset position of media data of each second in the original media file, whether media data of each second containing a key frame, the number of the memory management units contained in media data of each second, and the number of the data packets contained in media data of each second.

5. A media file on-demand method, wherein said method comprises:
the client sends a media on-demand request to the server, and receives the index information from said server;
in the media playing process, the client, according to said index information, acquires the requested time corresponding to the drag-and-drop position of the progress bar, and sends said requested time to said server by carrying it in the playing progress request;
the client receives the media data corresponding to said requested time from said server, and performs media playing.

6. The media file on-demand method as claimed in claim 5, wherein said index information comprises: the total time duration of the original media file, the total number of the data packets of the original media file, the size of each data packet, the size of the header of the original media file, the average bit rate, the total number of the memory management units, the starting offset position of media data of each second in the original media file, whether media data of each second containing a key frame, the number of the memory management units contained in each second, and the number of the data packets contained in each second.

7. The media file on-demand method as claimed in claim 6, wherein said acquiring the requested time corresponding to the drag-and-drop position of the progress bar specifically comprises:
the client, according to the length proportion of the drag-and-drop position of said progress bar to the total schedule and the total time duration of the original media file contained in said index information, acquires the first time corresponding to said drag-and-drop position;
the server, according to the information in said index information as to whether the media data of each second contains a key frame, judges whether the media data corresponding to said first time contains a key frame;
if the media data corresponding to said first time contains a key frame, then said first time is determined to be said requested time; otherwise, the second time containing a key frame, which is the closest to said first time is chosen to be said requested time.

8. A media file on-demand system, wherein said system comprises:
a client, said client sends a media on-demand request to the server; according to the index information from the server, acquires the requested time corresponding to the drag-and-drop position of the progress bar, and sends said requested time to said server by carrying it in the playing progress request; receives the media data corresponding to said requested time from said server, and performs media playing;
a server, said server provides the index information in the self-defining media file generated in advance according to the original media file to said client, according to the requested time in the playing progress request from said client, searches said index information for the starting offset position of the media data corresponding to said requested time; and according to said starting offset position of the media data, reads out the media data corresponding to said requested time in said self-defining media file, and provides said media data to said client.

9. The media file on-demand system as claimed in claim 8, wherein said server comprises:
an index information providing module, said index information providing module, upon receiving the media on-demand request from the client, provides the index information in the self-defining media file to said client, and is used for said server itself searching the index information;
a starting offset position searching module, said starting offset position searching module, upon receiving the playing progress request from said client, according to the requested time in said playing progress request, searches said index information to get the starting offset position of the media data corresponding to said requested time;
a media data reading module, said media data reading module, according to said starting offset position of the media data, reads out the media data corresponding to said requested time in said self-defining media file, and provides said media data to said client.

10. The media file on-demand system as claimed in claim 8, wherein said server further comprises: a self-defining media file generating module, which analyzes said original media file to derive the corresponding index information, and combines said original media file and said index information, so as to generate said self-defining media file.

11. The media file on-demand system as claimed in claim 8, wherein said client comprises:
a sending module, said sending module sends the media on-demand request and the playing progress request to the server, said playing progress request carrying the requested time therein;
a requested time acquiring module, said requested time acquiring module, in the media playing process, acquires the requested time corresponding to the drag-and-drop position of the progress bar;
a receiving module, said receiving module receives the index information and the media data from said server.

12. A server, wherein said server comprises:
an index information providing module, said index information providing module, upon receiving the media on-demand request from the client, provides the index information in the self-defining media file generated in advance according to the original media file to said client, and is used for said server itself searching the index information;
a starting offset position searching module, said starting offset position searching module, upon receiving the playing progress request from said client, according to the requested time in said playing progress request, searches said index information to get the starting offset position of the media data corresponding to said requested time;
a media data reading module, said media data reading module, according to said starting offset position of the media data, reads out the media data corresponding to said requested time in said self-defining media file, and provides said media data to said client.

13. The server as claimed in claim 12, wherein said media data reading module comprises:
a media data caching submodule, which caches the media data read out by said server from the disc of its own in the memory;
a media data updating submodule, which, in case the memory space of said server is full, deletes the media data with a lower frequency on-demand from said memory through the elimination algorithm.

14. The server as claimed in claim 12, wherein said server further comprises a self-defining media file generating module, which analyzes said original media file to derive the corresponding index information, and combines said original media file and said index information, so as to generate said self-defining media file.

15. A client, wherein said client comprises:
a sending module, said sending module sends the media on-demand request and the playing progress request to the server, said playing progress request carrying the requested time therein;
a requested time acquiring module, said requested time acquiring module, in the media playing process, acquires the requested time corresponding to the drag-and-drop position of the progress bar;
a receiving module, said receiving module receives the index information and the media data from said server.

16. The client as claimed in claim 15, wherein said requested time acquiring module comprises:
a first time acquiring submodule, which, according to the length proportion of said progress bar to the total schedule and the total time duration of the original media file contained in said index information, acquires the first time corresponding to said drag-and-drop position;
a first time judging submodule, which searches said index information, and judges whether the media data corresponding to said first time contains a key frame;
a requested time determining submodule, which, according to the result of the judgement, determines said first time to be the requested time corresponding to the drag-and-drop position, or, selects the second time containing a key frame, which is the closest to said first time to be the requested time corresponding to the drag-and-drop position.
